(19) United States
(12) Patent Application Publication
(10) Pub. No.: US 2011/0013761 A1
(43) Pub. Date: Jan. 20, 2011

(54) Communication System

(76) Inventor: Shean-Tung Lin, Taipei City (TW)

Correspondence Address: Yen Jung Sung, 30-47 37 St., Astoria, NY, 11103, US

(21) Appl. No.: 12/505,467

(22) Filed: Jul. 18, 2009

(51) Int. Cl. H04M 1/56

(52) U.S. Cl. 379/142.06

(57) ABSTRACT

A communication system includes a calling device, an answering device and a transmission device. The calling device is operable by a caller to make a call. The answering device includes telephones and computers corresponding to the telephones. The transmission device includes an actuating unit, a judging unit connected to the actuating unit and a database connected to the actuating unit. On receiving a call from the calling device, the judging unit provides data into the judging unit from the database so that the judging unit determines the identity of the caller. Then, the actuating unit actuates and provides the identity and data of the caller to at least one of the computers related to the call.

### BACKGROUND OF THE INVENTION

1. Field of the Invention

The present invention relates to a communication system and, more particularly, to a communication system for increasing service quality and working efficiency while reducing operation cost and resource consumption by showing the telephone number, identity, image and history of a caller.

2. Related Art

Telephone is the most common way for communication between people in offices. Web phone such as Skype and MSN cannot replace telephone completely.

The cost of using a web phone is lower than that of using a telephone. However, as the web phone is operated in a pull-call manner, a user of a computer has to check the web phone from time to time to know whether he or she got a call or not, and this is a waste of resource. Moreover, with a telephone or web phone, calls cannot be screened. Hence, the service quality and working efficiency are low, and the operation cost is high. Furthermore, for a corporate with branches abroad, the telephone cannot be used together with a computer to record meeting minutes or other information communicated during the call.

The present invention is therefore intended to obviate or at least alleviate the problems encountered in prior art.

### SUMMARY OF THE INVENTION

It is the primary objective of the present invention to provide a communication system for increasing service quality and working efficiency while reducing operation cost and resource consumption by showing the telephone number, identity, image and history of a caller.

To achieve the foregoing objective, the communication system includes a calling device, an answering device and a transmission device. The calling device is operable by a caller to make a call. The answering device includes telephones and computers corresponding to the telephones. The transmission device includes an actuating unit, a judging unit connected to the actuating unit and a database connected to the actuating unit. On receiving a call from the calling device, the judging unit provides data into the judging unit from the database so that the judging unit determines the identity of the caller. Then, the actuating unit actuates and provides the identity and data of the caller to at least one of the computers related to the call.

Other objectives, advantages and features of the present invention will become apparent from the following description referring to the attached drawings.

### BRIEF DESCRIPTION OF THE DRAWINGS

The present invention will be described via detailed illustration of the preferred embodiment referring to the drawings.

FIG. 1 is a perspective view of a communication system according to the preferred embodiment of the present invention.

FIG. 2 is a block diagram of the communication system of FIG. 1.

FIG. 3 is a more detailed perspective view of the communication system shown in FIG. 1.

### DETAILED DESCRIPTION OF THE PREFERRED EMBODIMENT

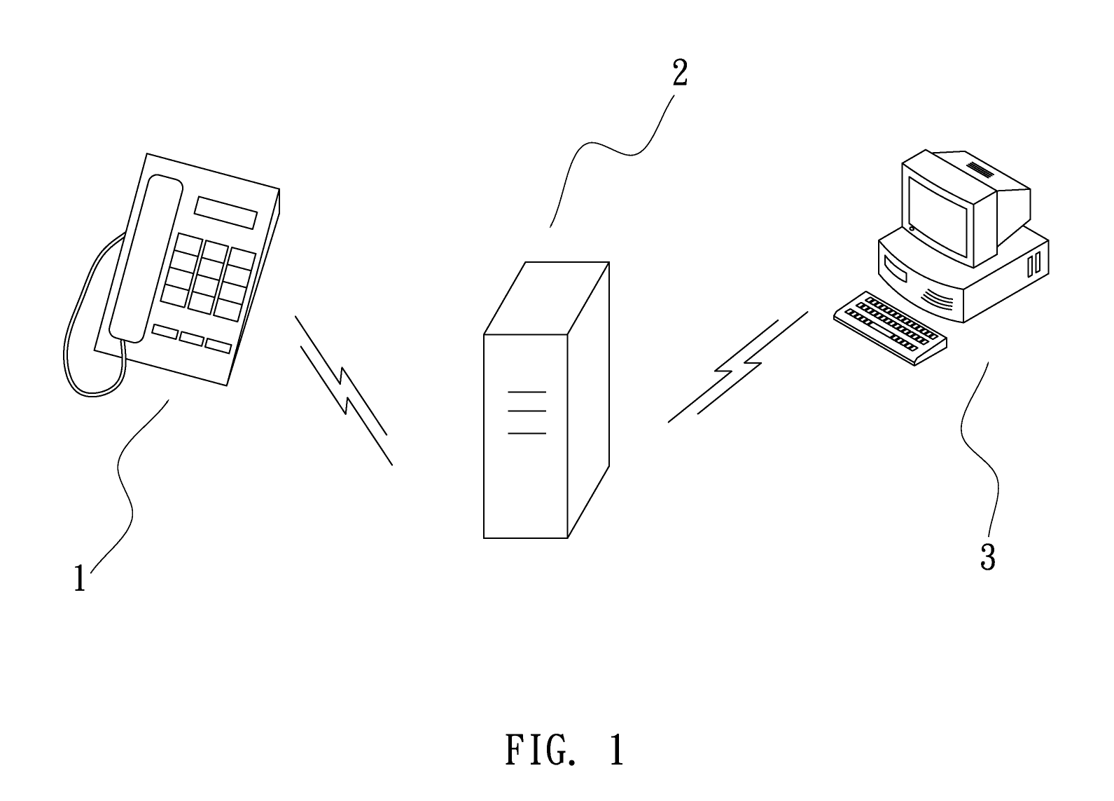

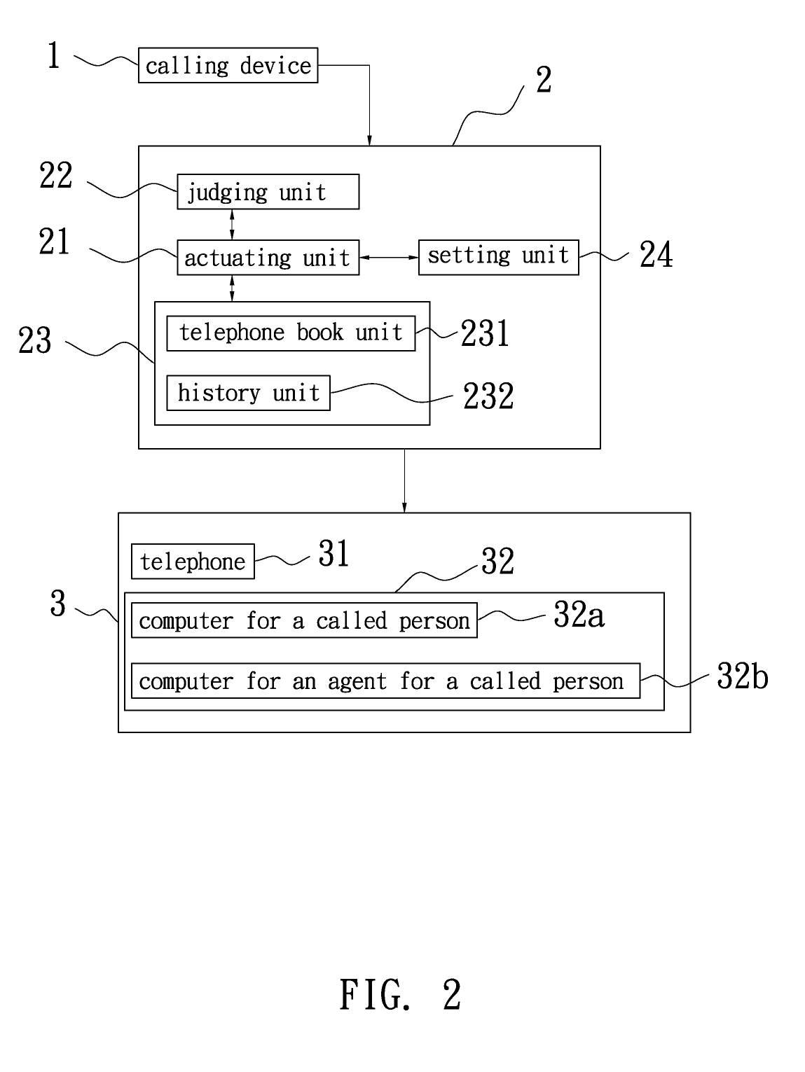

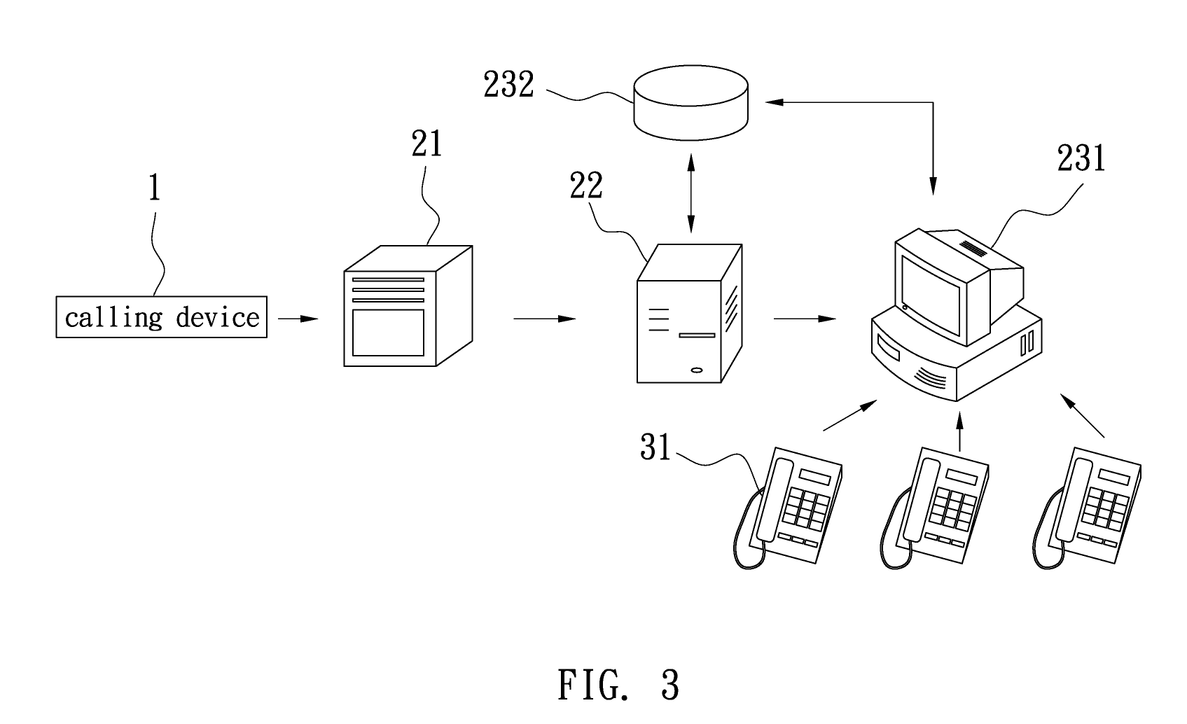

Referring to FIGS. 1 through 3, a communication system includes a calling device 1, a transmission device 2 and an answering device 3 according to the preferred embodiment of the present invention. The calling device 1 is preferably a telephone.

The transmission device 2 includes an actuating unit 21, a judging unit 22 connected to the actuating unit 21, a database 23 connected to the actuating unit 21 and a setting unit 24 connected to the actuating unit 21. The database 23 is divided into a telephone book unit 231 and a history unit 232. The communication between the transmission device 2 and the calling device 1 can be done by cables or in a wireless manner.

The answering device 3 includes a telephone 31 and computers 32. All of the computers 32 are connected to the actuating unit 21. The communication between the answering device 3 and the transmission device 2 can be done by cables or in a wireless manner.

In operation, when a person (“caller”) uses the calling device 1 to call another person (“called person”) using the answering device 3 through the transmission device 2, the actuating unit 21 actuates at least one of the computers 32 to increase the efficiency of using the telephone. This push-call manner avoids waste of resource of the computers 32. The push-call manner allows the called person to answer the call immediately.

At the same time, the actuating unit 21 instructs the judging unit 22 to check the telephone book unit 231 to determine the identity of the caller. Then, the actuating unit 21 causes the history unit 232 to provide information about the caller to the computer 32 of the called person. The computer 32 shows the information about the calling device 1. The called person can read the information and determine whether to answer the call.

Moreover, an enterprise resource programming (“ERP”) system and a personal system can be run on the computer 32. The ERP system includes information about customers, suppliers and others for example. The personal system includes OUTLOOK for example. Hence, while talking on the telephone, the called person can write down meeting minutes, take notes of things to be done, or initiate the ERP system or a CRM system to run an operation flow chart or record schedules. When the caller calls again, the answering device 3 can automatically show the information. Thus, the called person can provide quality service to the caller, and increase his or her working efficiency.

The computers 32 can be classified into computers 32a for called persons and computers 32b for agents for the called persons. Each of the computers 32a is related to one of the computers 32b. Each of the computers 32a is assigned to a manager or boss while a related one of the computers 32b is assigned to a secretary working for the manager. As a caller calls, one of the computers 32a and a related one of the computers 32b show information about the caller. A manger can decide to answer the call personally or let the secretary to answer the call.

If the identity of the caller is not found in the database 23, the caller is determined to be a new customer. Now, the setting unit 24 can be operated to enter data of the new customer into the database 23.

Furthermore, the communication system can be used in conference calls or international communication between branches of a corporate to reduce the cost of equipment. The images shown on the computers 32 can be shown in the caller's computer. With the telephones and computers, three persons or more can join in a conference.

Moreover, the communication system can be used in restaurants, pizza stores, rescue units, or domestic violence prevention bureaus as the actuating unit 21 actuates the computer 32 automatically on receiving a call from the call device 1.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A communication system comprising:
a calling device operable by a caller to make a call;
an answering device comprising telephones and computers corresponding to the telephones; and
a transmission device comprising an actuating unit, a judging unit connected to the actuating unit and a database connected to the actuating unit, wherein on receiving a call from the calling device, the judging unit provides data into the judging unit from the database so that the judging unit determines the identity of the caller, and then the actuating unit actuates and provides the identity and data of the caller to at least one of the computers related to the call.

2. The communication system according to claim 1, wherein the calling device is a telephone.

3. The communication system according to claim 1, wherein the calling device, the receiving device and the transmission device communicate with one another through cables.

4. The communication system according to claim 1, wherein the calling device, the receiving device and the transmission device communicate with one another in a wireless manner.

5. The communication system according to claim 1, wherein the transmission device comprises a setting unit connected to the actuating unit.

6. The communication system according to claim 1, wherein the database comprises a telephone book unit and a history unit both connected to the actuating unit.

7. The communication system according to claim 1, wherein the computers comprise computers assigned to called persons and computers assigned to agents for the called persons.
